(19) United States
(12) Patent Application Publication
(10) Pub. No.: US 2026/0197377 A1
(43) Pub. Date: Jul. 9, 2026

(54) DYNAMIC CONTENT CACHE

(71) Applicant: Telefonaktiebolaget LM Ericsson (publ), Stockholm (SE)

(72) Inventors: Victor GOMEZ-HIDALGO PEREZ, Torrijos Toledo (ES); Carlota VILLASANTE MARCOS, Madrid (ES); Miguel Angel MUÑOZ DE LA TORRE ALONSO, Madrid (ES)

(73) Assignee: Telefonaktiebolaget LM Ericsson (publ), Stockholm (SE)

(21) Appl. No.: 19/128,279

(22) PCT Filed: Nov. 17, 2022
(86) PCT No.: PCT/EP2022/082308

§ 371 Date: May 8, 2025

(30) Foreign Application Priority Data
Nov. 11, 2022 (EP) 22383084.5

(51) Int. Cl. H04L 67/568; H04L 67/303

(52) U.S. Cl. CPC H04L 67/568; H04L 67/303

(57) ABSTRACT

There is provided a method of operating a user plane network node (110) in a communication network. The method comprises sending a registration request (202) to a profile storage network node (107) in the communication network to register the capabilities of the user plane network node (110) with the communication network. The capabilities of the user plane network node (110) comprise a capability, responsive to a cache request, to dynamically reserve cache resources for use by one or more content providers.

### TECHNICAL FIELD

This disclosure relates to enabling caching of content from a content provider in a communication network.

### BACKGROUND

In 5^{th} Generation (5G) networks, a service-based architecture is used for the core network, which is broken down into communicating services known as Network Functions (NFs).

FIG. 1 illustrates part of a 5G system reference architecture 101 showing service-based interfaces used within the Control Plane (CP). It will be appreciated that not all types of NFs used in 5G are depicted. Service-based interfaces are represented in the format Nxyz and point to point interfaces in the format Nx. The reference architecture 101 shown in FIG. 1 comprises the following types of NF: a Unified Data Repository (UDR) 102 that has a Nudr interface, a Network Exposure Function (NEF) 103 that has a Nnef interface, a Network Data Analytics Function (NWDAF) 104 that has a Nnwdaf interface, an Application Function (AF) 105 that has a Naf interface, a Policy Control Function (PCF) 106 that has a Npcf interface, a Network Repository Function (NRF) 107 that has a Nnrf interface, an Access and Mobility Management Function (AMF) 108 that has a Namf interface, and a Session Management Function (SMF) 109 that has a Nsmf interface. The SMF 109 has an N4 interface to a User Plane Function (UPF) 110.

Although not shown in FIG. 1, the AMF 108 has an N1 interface to a user equipment (UE), and an N2 interface to an access network (AN), which can be a radio access network (RAN).

The UDR 102 stores data grouped into distinct collections of subscription-related information, such as Subscription Data, Policy Data, Structured Data for Exposure, and Application Data.

The NEF 103 supports different functionality and specifically in the context of this disclosure, the NEF 103 supports different Exposure Application Programming Interfaces (APIs).

The NWDAF 104 supports the collection and analysis of data within the network.

The AF 105 interacts with the Third Generation Partnership Project (3GPP) Core Network (CN), and specifically in the context of this disclosure, allows external parties to use the Exposure APIs offered by the network operator.

The PCF 106 supports a unified policy framework to govern the network behaviour. Specifically, the PCF 106 can provide Policy and Charging Control (PCC) rules to a Policy and Charging Enforcement Function (PCEF), i.e. the SMF 109/UPF 110 that enforces policy and charging decisions according to provisioned PCC rules.

The NRF 107 provides a NF discovery and selection service for other NFs. In this way, any NF can discover and select services offered by other NFs.

The AMF 108 is responsible for managing mobility of UEs in the network between different gNBs (the base stations in 5G).

The SMF 109 supports different functionalities, for example the SMF 109 receives PCC rules from the PCF 106 and configures the UPF 110 accordingly.

The UPF 110 supports the handling of user plane traffic based on the rules received from the SMF 109, for example packet inspection and different enforcement actions such as Quality of Service (QoS) handling.

A content delivery network (CDN), which is also known as a content distribution network (CDN), is a geographically distributed network of proxy servers and their data centers. A goal is to provide high availability and performance by distributing the service spatially relative to end users. CDNs came into existence in the late 1990s as a means for alleviating the performance bottlenecks of the Internet as the Internet was starting to become a mission-critical medium for people and enterprises. Since then, CDNs have grown to serve a large portion of the Internet content today, including web objects (e.g. text, graphics and scripts), downloadable objects (e.g. media files, software, documents), applications (e.g. e-commerce, portals), live streaming media, on-demand streaming media, and social media sites.

CDNs are a layer in the Internet ecosystem. Content owners such as media companies and e-commerce vendors pay CDN operators to deliver their content to their end users.

The main objective of a CDN is to deliver content at the highest speed to users in different geographic locations, and this is achieved by a process of replication. CDNs can provide web content services by duplicating content from other servers and directing it to users from the nearest data center.

A recent study has found that the video streaming services provided by Netflix and YouTube accounted for almost half of the total Internet traffic in North America, meaning that mobile network operators (MNOs) Internet Protocol (IP) networks are effectively video transport networks rather than the Internet. With an ever-increasing number of users and higher resolution videos, the traffic of these two streaming services (and hence the delivery costs associated with this traffic) are consistently increasing. MNOs and Over-The-Top (OTT) video streaming service providers have had different strategies to minimise these costs. Two strategies used by these OTT service providers (which are also referred to herein as “Content Providers”) are discussed below.

Google (that owns YouTube) delivers YouTube traffic worldwide through its own CDN comprising at least 13 data centers located in the USA, Europe and Asia. With this limited number of data centers, handling the fast-growing YouTube traffic is difficult. In addition, users in a country without a Google data center can experience frequent buffering problems while using YouTube.

In an effort to address such problems, Google has provided telecom operators with Google Global Cache (GGC), its own edge server, for free since around 2008. Google has installed GGC servers (hardware (HW) and software (SW) in the MNO's Internet Data Centers (IDCs) and has managed their operation as well (through remote management). The MNOs have in return provided Google with server rack spaces, power and Gigabit Ethernet (GE) ports for free.

MNOs like this approach as it can bring down the transit costs due to the drastically decreased YouTube traffic coming from external networks, and also because they no longer have to deal with customers' complaints about their relatively slower YouTube traffic.

Google also liked this approach as it can provide YouTube users with improved Quality of Experience (QoE) and higher resolution video services without the burden of IDC fees. Since this strategy was beneficial to both of them (i.e. Google itself and the MNOs), neither of them needed to pay. GGCs have already been used by most MNOs in North America and Europe, and by some MNOs in South Korea. Google has therefore successfully expanded its CDN throughout the world, even into the networks of telecom operators.

Netflix applies generally the same technical strategy to content provision as Google. To serve its customers, Netflix uses fee-based CDN services provided by third parties. However, Netflix has to pay CDN service fees to CDN providers, which Google avoids by providing their own CDN and GGC servers. Furthermore, Netflix has to pay higher costs in order to provide higher resolution video services (e.g. full High Definition (HD) or 4K) in order to be able to attract more subscribers.

Just like GGC, Netflix Cache was developed and offered for use by MNOs at no charge, and operated by Netflix, an OTT service provider. Again, the MNOs have supplied rack spaces, power and GE ports in their IDCs to Netflix at no charge.

Currently, Netflix Cache has been deployed inside the networks of many MNOs in the USA, Canada, Central America and Europe. In particular, in Europe all Netflix traffic is now delivered to Netflix users through Netflix Cache, not through global CDNs.

Netflix started providing full HD services (1920×1080 resolution, 5-7 megabits per second (Mbps)) and three-dimensional (3D) video services (12 mbps) in January 2013. Netflix subscribers now can enjoy high resolution services at no extra charge. However, these high resolution services are only available to subscribers of the MNOs who have Netflix Cache placed in their networks. Such restrictions are intended specifically to promote an MNO's deployment of Netflix Cache, thereby bringing down CDN costs and providing high resolution services without paying IDC fees to MNOs.

When higher resolution Netflix content became available to subscribers of some MNOs, other MNOs without a Netflix Cache objected that the full HD and 3D services should also be available to the subscribers of MNOs that had not deployed a Netflix Cache. A long standing issue was the ‘network neutrality’ of MNOs, but selective deployment of Netflix cache meant that there was now an issue of the neutrality of content, meaning that OTT service providers should not discriminate among MNOs in providing their content to users.

This problem was mitigated by Netflix having more CDNs deployed in the networks of MNOs across the world without any cost, just like Google. YouTube and Netflix, currently the two top OTT service providers (in terms of data volume), have found a way to put their proprietary cache inside the networks of MNOs by taking advantage of their desirable content and huge user bases.

The concept of MNO CDN and transparent caches was originally formed to reduce network costs through caching OTT service provider's traffic in the network of MNOs, and to generate new profit sources for the MNOs. MNOs CDNs and Transparent Caches can be developed by third party vendors and provided to the MNOs for deployment in their networks. Thus, the third party vendors may make some profit from this. The MNOs may also build a CDN in their network and collect CDN service fees from OTT service providers. However, for services like YouTube and Netflix having their own proprietary cache inside the networks of MNOs, only those OTT service providers can earn revenue from these services.

Thus, the following problems have been identified with the current arrangements. Firstly, large content providers, such as Netflix and YouTube, that have a global CDN and use peering with an Internet Service Provider (ISP) or MNO so that their content is as near to users as possible, are also placing their content inside the ISP's or MNO's networks (via, e.g., Netflix Open Connect, Google Global Cache). Secondly, these types of solutions are now being implemented differently. Each OTT Content Provider offers its own solution with different implementation details, different operations are needed, and there are different conditions, which is very inefficient. Thirdly, other ISPs/MNOs want higher resolution services to also be available to the subscribers of ISPs/MNOs that have not deployed a Netflix or YouTube cache.

### SUMMARY

Certain aspects of the disclosure and their embodiments may provide solutions to these or other challenges. In particular, this disclosure proposes a mechanism which addresses the above problems and is based on a common solution through a new API that allows the content providers to request that a MNO reserves MNO's resources (e.g. hardware) to allocate content (cache). Thus, this API can allow the Content Provider, via an AF, to request a MNO, via the NEF, to reserve MNOs resources (e.g. hardware) to allocate content (cache).

Certain embodiments may provide one or more of the following technical advantage(s). One advantage is that it can allow MNOs to reduce the Total Cost of Ownership (TCO) and Operational Expenditures (OPEX) due to a single and unified solution instead of one solution per Content Provider. Another advantage is that it can allow the MNO to provide caching services in an optimised and flexible way. Another advantage is that it can allow the MNO to get a potential new source of revenue. Yet another advantage is that it can allows the content provider to deliver content quickly and efficiently to end users. Another advantage is that the size of the cache assigned to each Content Provider can be dynamically adjusted, for example it can be adjusted depending on traffic classification. If the amount of traffic of a Content Provider in a network increases, the size of the cache assigned to it can also increase. If the amount of traffic decreases, the size of the cache can also decrease. Yet another advantage is that the QoE offered by MNOs can be improved, and the traffic sent to an Internet Exchange (IX) is reduced, thus reducing transit costs. Finally, another advantage is that it can prevent new rapidly-growing applications from being hampered in their growth by limits on content delivery capabilities.

According to a first aspect, there is provided a method of operating a user plane network node in a communication network. The method comprises sending a registration request to a profile storage network node in the communication network to register the capabilities of the user plane network node with the communication network. The capabilities of the user plane network node comprise a capability, responsive to a cache request, to dynamically reserve cache resources for use by one or more content providers.

According to a second aspect, there is provided a method of operating a profile storage network node in a communication network. The method comprises storing a profile for a user plane network node that is in the communication network. The stored profile indicates that the user plane network node has a capability, responsive to a cache request, to dynamically reserve cache resources for use by one or more content providers.

According to a third aspect, there is provided a method of operating an application network node. The method comprises sending, to an exposure network node in a communication network, a cache request that requests cache resources in the communication network be reserved for use by a first content provider.

According to a fourth aspect, there is provided a method of operating an exposure network node in a communication network. The method comprises, in response to a cache request that requests cache resources in the communication network be reserved for use by a first content provider, reserving cache resources in the communication network for use by the first content provider; and sending, to the application network node, a cache notification request indicating the reserved cache resources.

According to a fifth aspect, there is provided a method of operating a user data storage network node in a communication network. The method comprises: receiving, from an exposure network node, a write request that comprises information from a cache request that requests cache resources in the communication network be reserved for use by a first content provider.

According to a sixth aspect, there is provided a computer program product comprising a computer readable medium having computer readable code embodied therein, the computer readable code being configured such that, on execution by a suitable computer or processor, the computer or processor is caused to perform the method according to any of the preceding aspects.

According to a seventh aspect, there is provided a network node configured to perform the method of any of the first to fifth aspects.

According to an eighth aspect, there is provided a network node comprising a processor and a memory, said memory containing instructions executable by said processor whereby said network node is operative to perform the method of any of the first to fifth aspects.

### BRIEF DESCRIPTION OF THE DRAWINGS

Some of the embodiments contemplated herein will now be described more fully with reference to the accompanying drawings, in which:

FIG. 1 illustrates part of a 5G system reference architecture;

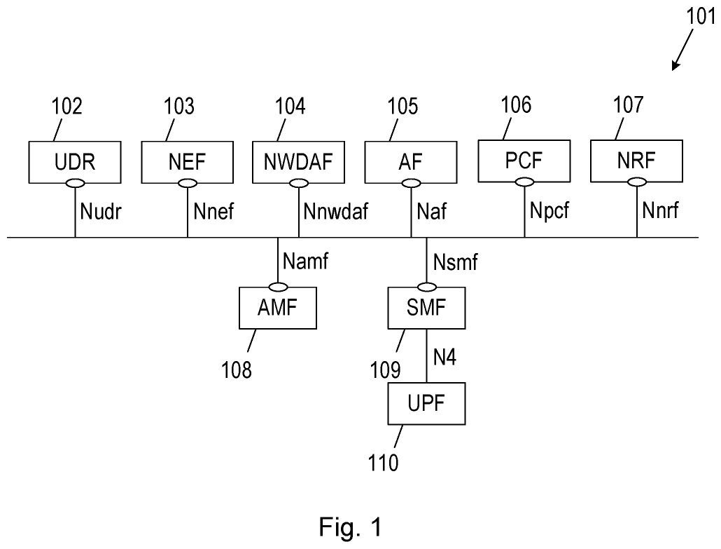

FIG. 2 is a signalling diagram that illustrates an embodiment of the techniques described herein;

FIG. 3 is an exemplary method of operating a user plane network node;

FIG. 4 is an exemplary method of operating a profile storage network node;

FIG. 5 is an exemplary method of operating an application network node;

FIG. 6 is an exemplary method of operating an exposure network node;

FIG. 7 is an exemplary method of operating a user data storage network node;

FIG. 8 is a block diagram of a network node in accordance with some embodiments; and

FIG. 9 is a block diagram illustrating a virtualization environment in which functions implemented by some embodiments may be virtualized.

### DETAILED DESCRIPTION

Some of the embodiments contemplated herein will now be described more fully with reference to the accompanying drawings. Embodiments are provided by way of example to convey the scope of the subject matter to those skilled in the art.

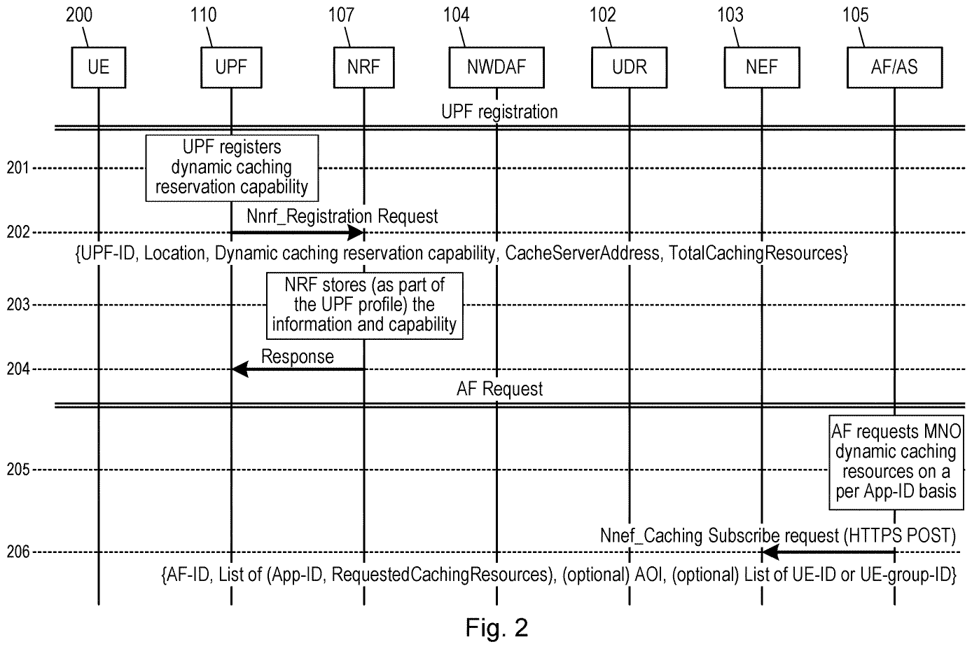

The signalling diagram in FIG. 2 illustrates an embodiment of the techniques described herein. FIG. 2 shows the signalling between a number of network functions (NFs) in a network that also includes a User Equipment (UE) 200. Thus, FIG. 2 shows the signalling between a UDR 102, a NEF 103, a NWDAF 104, an AF 105, a NRF 107 and a UPF 110. The UDR 102, NEF 103, NWDAF 104, NRF 107 and UPF 110 are part of a communication network operated by a particular MNO. The AF 105 is an external entity that is not part of the MNO's network.

Although not shown in FIG. 2, the MNO's network comprises a cache server that provides the cache resources that can be reserved for use by particular content providers. In some embodiments, the cache server is a Caching Service Function (SF), i.e. a SF that acts as a cache. In alternative embodiments, the cache server may be a different type of entity, i.e. not a SF. In some embodiments, the cache server (and in particular the cache resources) are co-located with (e.g. integrated within) the UPF 110. A single MNO can have multiple caches (i.e. multiple cache servers), for example each UPF 110 may have a co-located cache or even a SF acting as a cache, which might serve a single UPF instance or several UPF 110 instances, e.g. in a certain geographical area.

The process illustrated in FIG. 2 comprises a number of phases: a UPF registration phase (which is generally indicated by step 201) in which the UPF 110 registers with the NRF 107; an AF Request phase (which is generally indicated by step 205) in which the AF 105 requests dynamic caching resources; a UPF Discovery phase (which is generally indicated by step 212) in which the NEF 103 discovers the UPF 110; a first NEF logic phase (which is generally indicated by step 217) in which the NEF 103 retrieves caching requests from different content providers; an Analytic Subscription phase (which is generally indicated by step 221) in which the NWDAF 104 obtains analytic information; and a second NEF logic phase (which is generally indicated by step 228) in which the NEF 103 dynamically assigns cache resources.

In the UPF registration phase 201, the MNO that is operating the communication network registers the UPF's support of a dynamic caching reservation capability. That is, the UPF 110 registers with the NRF 107 and indicates that it has the capability to dynamically reserve cache storage for use by one or more external content providers (e.g. a video streaming service). In some embodiments, the dynamic caching reservation capability can be registered on a per MNO cache instance basis.

Thus, the UPF 110 sends a registration request 202 to the NRF 107. This registration request 202 can be a Nnrf_Registration Request message. As an example, assuming the UPF 110 is co-located with a Caching SF, the UPF 110 can register itself in the NRF 107.

In step 203, information about the dynamic cache reservation capability of the UPF 110 contained in the registration request 202 is stored by the NRF 107. This information can be stored in the NRF 107 as part of an extended NF profile (NFProfile) for a UPF 110. That is, the conventional profile for a UPF 110 that would be stored by an NRF 107 is extended to enable information relating to dynamic cache reservation capability to be stored.

In step 204, the NRF 107 sends a response message 204 to the UPF 110 indicating that the UPF registration procedure has been successfully completed.

One or more of the following types of information can be communicated to the NRF 107 in the registration request 202, and stored in the NF profile in step 203. The registration request 202 can include:
a UPF identifier for the UPF 110, e.g. a UPF-ID;
a location of the UPF 110 (e.g. a geographic (geo-) location);
an indication that the UPF 110 has or supports a dynamic caching reservation capability (which is signalled as “Dynamic Caching Reservation Capability”);
an address of the cache server, which is referred to as ‘CacheServerAddress’;
an amount of resources available for caching, which is referred to as ‘TotalCachingResources’, and which can be, for example, 100 TeraBytes (TB). The amount of resources available for caching may be the total amount of caching resources (i.e. including resources that are already in use by or reserved for a content provider), or a remaining amount of caching resources that are still available to be reserved or used by a content provider.

Thus, with this information in the registration request, the NRF 107 has information identifying the UPF 110, information indicating that the UPF 110 is able to dynamically reserve cache storage for data from an external content provider, information indicating the address of the cache server to which data to be cached is sent, and information indicating how much storage space in the cache is available to be reserved.

In the AF Request phase 205, a Content Provider (represented by the AF 105) interacts with the MNO through the NEF 103 to dynamically reserve cache resources in which the Content Provider can allocate store their content. Thus, the AF 105 is to request dynamic caching resources of the MNO, as indicated by step 205.

In step 206, the AF 105 requests reservation of some or all of the available cache resources by sending a cache subscribe request to the NEF 103. These dynamic resources may be requested on a per Application Identifier (App-ID) basis. Thus, the AF 105 can request one set of cache resources for a first application or first content provider, and the AF 105 can subsequently request a further set of cache resources for a second application or second content provider. In some embodiments, the cache subscribe request 206 can indicate multiple cache requests relating to multiple applications and/or content providers.

The cache subscribe request 206 can be part of a (new) Nnef API/service which is labelled “Nnef_Caching” in FIG. 2. The subscribe request 206 can include the following types of information:
an AF identifier for the AF 105, e.g. an AF-ID, which identifies the content provider (e.g. HBO Inc).
a list comprising one or more entries, each entry comprising:
   an application identifier, e.g. App-ID, that identifies the application (e.g. HBO Max, as a video streaming service of HBO Inc., YouTube, etc.);
   a cache amount representing the amount of cache resources requested for the application—this cache amount is labelled “RequestedCachingResources” in FIG. 2.

In some embodiments, the cache subscribe request 206 can comprise further types of information. One additional type of information that can be included in the cache subscribe request 206 is an Area of Interest (AOI). The AOI indicates a particular geographical area, and can be used by an AF 105 to request caching resources in a particular location (e.g. an AF (Google) may only want to request cache resources for YouTube in a particular city). Another type of information that can be included in the cache subscribe request 206 is a list of UE identifiers, or one or more identifiers for a group of UEs (denoted UE-ID or UE-group-ID respectively). These identifiers identify the subscriber(s) or one or more subscriber groups for which the request applies to. In some embodiments, when no UE identifiers or UE group identifiers are present in the cache subscribe request 206, the NEF 103 can interpret the cache subscribe request 206 as applying to every subscriber/UE.

After receiving the cache subscribe request 206, the NEF 103 determines if the request is authorised (step 207), and the NEF 103 sends a Write Request 208 to the UDR 102 if the cache subscribe request 206 is authorised. The NEF 103 can determine if the request is authorised in a number of different ways. For example, the NEF 103 can determine whether the AF 105 that sent the request 206 is authorised to send such requests to the NEF 103.

The Write Request 208 requests the UDR 102 store the cache subscribe request 206 from the AF 105. In particular, the UDR 102 stores the information relating to the cache subscribe request 206. The Write Request 208 can contain the same information as the Caching Subscribe Request 206 (e.g. the AF identifier, list of application identifiers and respective cache amounts, etc.), and indicate the subject of the request, which, for a cache subscribe request, is indicated as “DynamicCachingRequest”.

In step 209 the UDR 102 stores the details of the AF request for dynamic reservation of cache resources that was received in the Write Request 208. The information for this AF request is stored by the UDR 102 in addition to information about other types of requests from other AFs 105. The information can be stored by the UDR 102 on a per application (i.e. a per App-ID) basis. The information for the AF request can be stored in an extension to the conventional Application Data that is stored in a UDR 102.

After storing the request information, the UDR 102 sends a response message 210 to the NEF 103 to confirm that the request information has been stored, and the NEF 103 sends a corresponding response message 210 to the AF 105 to confirm that the request information has been stored in the UDR 102.

In the UPF Discovery phase 212, the NEF 103 triggers a UPF discovery procedure towards the NRF 107. This discovery procedure is used to identify a UPF 110 that is able to fulfil the AF request.

Thus, the NEF 103 sends a discovery request 213 to the NRF 107. This discovery request 213 is a “Nnrf_Discovery Request” in FIG. 2. The discovery request 213 indicates one or more of the following criteria for the NF that would fulfil the discovery request 213:
the type of NF that the discovery request relates to, in this case, a UPF, and this field in the discovery request 213 is denoted “NFType”;
an AOI (corresponding to the AOI received in the caching subscribe request 216);
an indication that the UPF 110 discovered by the discovery request 213 should have capability for dynamic caching reservation (which is represented by “Dynamic caching reservation capability” in the discovery request 213 in FIG. 2);
an indication of the amount of cache resources required (which is represented by “RequestedCachingResources” in the discovery request 213 in FIG. 2).

In step 214 the NRF 107 identifies one or more UPFs 110 in the communication network that meet the criteria specified in the discovery request 213. If no suitable UPF 110 is identified, the NRF 107 can respond to the NEF 103 indicating the discovery request 213 cannot be fulfilled. However, if one or more suitable UPFs 110 are identified (i.e. UPFs 110 that have the capability to dynamically reserve cache and that have at least the requested amount of cache resources available), the NRF 107 sends a response message 215 to the NEF 103 that identifies UPF(s) 110 that satisfy the criteria in the discovery request 213. The response message 215 can comprise information identifying the UPF(s) 110, including an identifier for the UPF 110 (e.g. UPF-ID), an address of the cache server (‘CacheServerAddress’) and/or an amount of resources available for caching (‘TotalCachingResources’).

After receiving the response message 215, the NEF 103 stores the information about the identified UPF(s) 110 (step 216).

In the first NEF logic phase 217 the NEF 103 retrieves the stored caching requests that may have originated from different content providers from the UDR 102. Therefore, the NEF 103 sends a Read Request 218 to the UDR 102 to request the dynamic caching requests that have been received from content providers. The Read Request 218 therefore indicates the request subject as “DynamicCachingRequests”.

In step 219 the UDR 102 identifies any stored active dynamic caching requests from Content Providers, and sends a Response message 220 to the NEF 103 indicating the identified requests (if any). A dynamic caching request is active until the caching subscribe request (206) expires or is terminated. These dynamic caching requests were previously stored according to the Write Request 208 and storing step 209, so the Response message 220 can include information about each dynamic caching request, such as the AF identifier for the relevant AF 105, e.g. an AF-ID, and a list of application identifiers, e.g. App-IDs, and respective cache amounts requested for the application (“RequestedCachingResources”).

In the Analytic Subscription phase 221 the NEF 103 subscribes to UE communication analytics (i.e. analytics of UE communications) and the NWDAF 104 obtains analytic information. Therefore, the NEF 103 sends an analytics subscribe request 222 to the NWDAF 104 (this request 222 is labelled “Nnwdaf_Analytic Subscribe Request” in FIG. 2). This analytics subscribe request 222 can include one or more of the following types of information:
an analytics identifier, e.g. an Analytic-ID, which identifies the analytics subject as UE communications (“UECommunication”);
a list application identifiers, e.g. App-IDs, that identifies the application(s)—this list can include application identifiers for all active dynamic caching requests, potentially from different Content Providers;
an AOI; and/or
a list of UE identifiers, or one or more identifiers for a group of UEs (denoted UE-ID or UE-group-ID respectively).

The NWDAF 104 registers the subscription request and sends a Response message 223 confirming the subscription request.

In step 224, the NWDAF 104 initiates data collection about UE communications. This data can be collected using the UPF 110.

In step 225, the NWDAF 104 performs analytics processes on the collected data. For example, the NWDAF 104 can analyse the collected UE communication data to determine times and/or locations at which particular services are being used (for example the NWDAF 104 may determine that in the evening there may be more UEs using a video streaming service of a first Content Provider in a residential area than during the day, or the NWDAF 104 may determine that a second Content Provider's service has particularly high use in an area popular with tourists).

The NWDAF 104 then sends a Notify Request 226 to the NEF 103 indicating that analytics results are available. This Notify Request 226 is denoted “Nnwdaf_Analytic Notify request” in FIG. 2. The Notify Request 226 can include information identifying the subscription request that the Notify Request 226 relates to (e.g. it can include the Analytic-ID “UECommunication”) and the Notify Request 226 can also include the result of the analytics (“AnalyticResult”). The NEF 103 can send a Response message 227 to the NWDAF 104 to acknowledge receipt of the Notify Request 226.

In the second NEF logic phase 228, the NEF 103 dynamically assigns cache resources. In particular embodiments the NEF 103 can dynamically assign caching resources on a per application basis in step 228, and then notify the Content Provider (i.e. the AF 105) about the assigned cache resources. In some embodiments, the NEF 103 can take the analytics results provided by the NWDAF 104 into account when assigning cache resources. In the above example where the NWDAF 104 identifies that there are more UEs using a video streaming service of a first Content Provider in a residential area in the evening than during the day, the NEF 103 can assign more cache resources to the video streaming service of the first Content Provider in the evening than during the day.

Once the NEF 103 has determined the cache resource assignment for a particular Content Provider/application, the NEF 103 sends a Caching Notify Request 229 to the AF 105 to indicate to the AF 105 the location of the cache and the amount of cache storage that is assigned to the AF 105. The Caching Notify Request 229 is a “Nnef_Caching Notify Request” message. The Caching Notify Request 229 can comprise one or more of an address of the cache server (e.g. ‘CacheServerAddress’) and a list of application identifiers, e.g. App-IDs, that identifies the application(s) and the respective amounts of cache resources assigned to the application(s) (“AssignedCachingResources”). The AF 105 sends a Response message 230 acknowledging the Caching Notify Request message 229.

In step 231, the Content Provider/AF 105 sends the content to be cached in the communication network according to the dynamically assigned caching resources. That is, the Content Provider sends content up to the amount of the assigned cache resources for storage in the cache. The Content Provider can send the content to be cached on a per-application basis.

It will be appreciated that while FIG. 2 shows a single Caching Notify Request message 229, if the assigned cache resources change, further Caching Notify Request messages 229 can be sent to the AF 105 so that the AF 105 can manage content updates dynamically. For example, some applications, such as YouTube, may want to dynamically refresh their content. As another example, an application may be used more or less than expected, and the assigned cache resources can be increased or decreased accordingly. In another example, if with a given cache resource assignment there is a lot of traffic for a given application (e.g. YouTube) that is not being served from the communication network's cache servers (i.e. the content is being served from outside the MNO's network, incurring transit costs), action can be taken to reduce the level of this traffic. For example, additional cache resources can be assigned to the application so that the content is cached in the network, and/or the communication network 100 (e.g. the NEF 103) can request that the AF/AS 105 refreshes the content in the existing cache.

In FIG. 2, it is assumed that the caching of the content is handled at an application level, where the Content Provider has a connection to the cache server (e.g. as enabled by the CacheServerAddress sent to the AF/AS 105 in Caching Notify Request message 229. Alternatively, it is possible for the Content Provider to request the MNO to refresh the content in the cache server, for example if the Content Provider does not have a connection to the cache server. In this case, the AF 105 can send a refresh request to the UPF 110 via the NEF 105.

In the example shown in FIG. 2, it is assumed that the UPF 110 includes the cache resources (e.g. as an embedded SF). However, in alternative embodiments, the cache resources may be separate/external to the UPF 110 (e.g. the cache resources can be co-located with the UPF 110). In embodiments where the cache resources are external/separate from the UPF 110, the UPF 110 can use conventional service chaining mechanisms, e.g. using Network Service Header (NSH) metadata.

While the technique of dynamic cache assignment is described in detail with reference to a 5G network architecture, it will be appreciated that the technique can also be used in other types of network architecture, including a 4^{th} Generation (4G) network, which is also known as Long Term Evolution (LTE) network. The flow of operations and signalling/messaging between nodes is generally the same in 5G as it is in 4G, but the 4G network architecture is different to the 5G service-based architecture. The correspondence between the operations of the NFs in the 5G service-based architecture according to the techniques described herein and the operations of the nodes in a 4G network in implementing the techniques described herein is set out below.

The AF 105 corresponds to a Service Capability Server/Application Server (SCS/AS) in 4G. The NEF 103 corresponds to a Service Capability Exposure Function (SCEF) in 4G. The UDR 102 corresponds to a Subscriber Profile Repository (SPR) in 4G. The PCF 106 corresponds to a Policy and Charging Rules Function (PCRF) in 4G. The SMF 109 corresponds to a Packet Data Network Gateway-Control Plane (PGW-C) or Traffic Detection Function-Control Plane (TDF-C) in 4G. The UPF 110 corresponds to a PGW-User Plane (PGW-U) or TDF-User Plane (TDF-U).

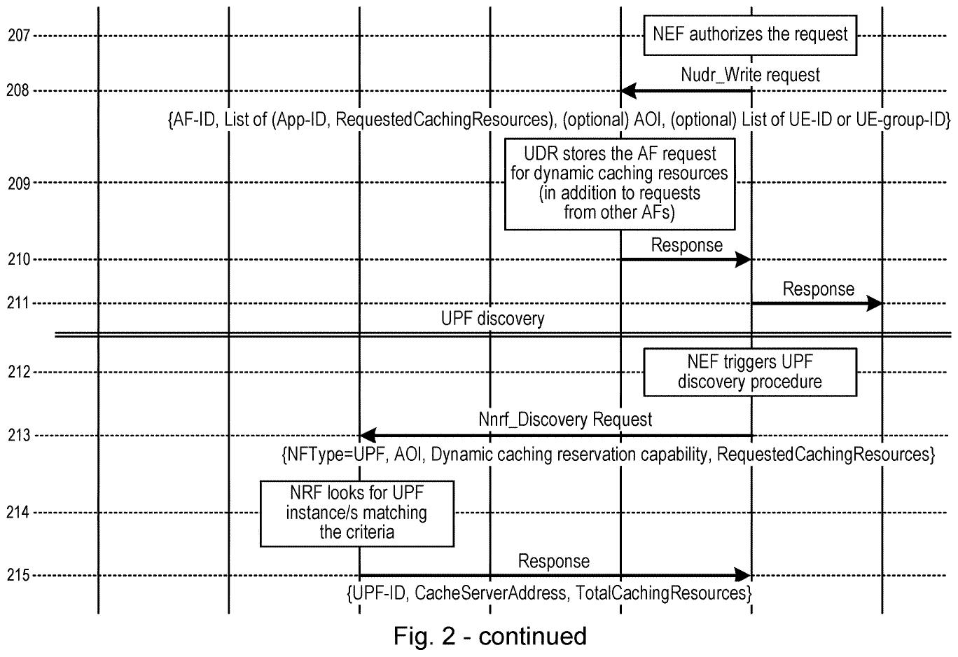

FIG. 3 is a flow chart illustrating a method of operating a user plane network node 110 (e.g. UPF, PGW-U, TDF-U) according to various embodiments. The user plane network node 110 is part of a communication network. The user plane network node 110 may perform the method in response to executing suitably formulated computer readable code. The computer readable code may be embodied or stored on a computer readable medium, such as a memory chip, optical disc, or other storage medium. The computer readable medium may be part of a computer program product.

In step 301, the user plane network node 110 sends a registration request 202 to a profile storage network node 107 in the communication network to register the capabilities of the user plane network node 110 with the communication network. The capabilities of the user plane network node 110 comprise a capability, responsive to a cache request, to dynamically reserve cache resources for use by one or more content providers.

The registration request 202 may comprise one or more of: an indication that the user plane network node 110 supports the capability to dynamically reserve cache resources; an address of a cache server that comprises or controls the dynamically reservable cache resources; and an amount of cache resources available to be reserved.

The user plane network node 110 may further receive a response 204 from the profile storage network node 107 indicating that a profile for the user plane network node 110 has been stored. The stored profile indicates the capability of the user plane network node 110 to dynamically reserve cache resources responsive to a cache request.

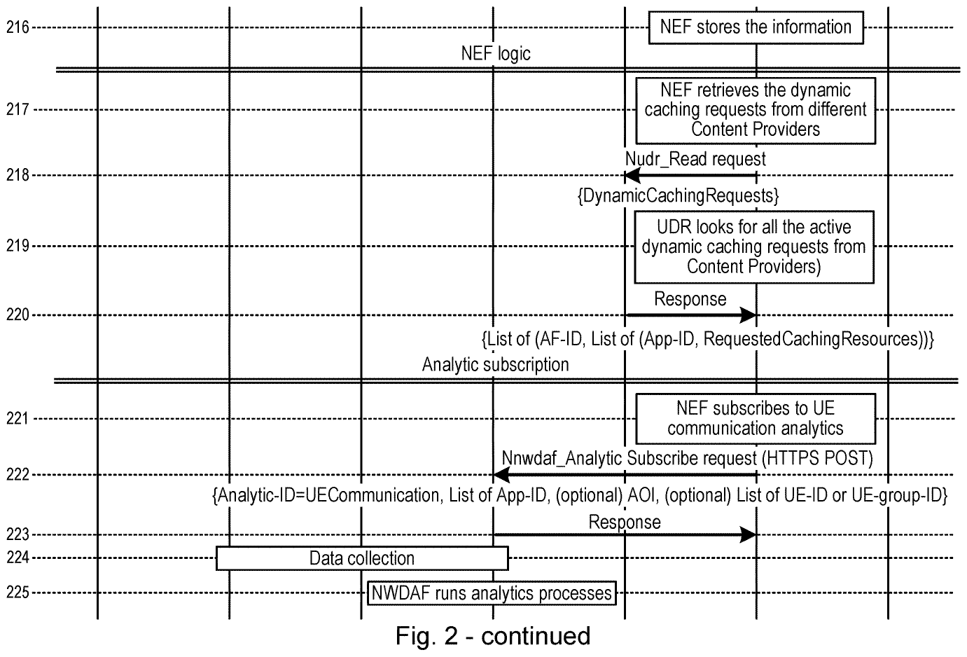

FIG. 4 is a flow chart illustrating a method of operating a profile storage network node 107 (e.g. a NRF) according to various embodiments. The profile storage network node 107 is part of a communication network. The profile storage network node 110 may perform the method in response to executing suitably formulated computer readable code. The computer readable code may be embodied or stored on a computer readable medium, such as a memory chip, optical disc, or other storage medium. The computer readable medium may be part of a computer program product.

In step 401 the profile storage network node 107 stores 203 a profile for a user plane network node 110 that is in the communication network. The stored profile indicates that the user plane network node 110 has a capability, responsive to a cache request, to dynamically reserve cache resources for use by one or more content providers.

The stored profile may further indicate one or more of: an address of a cache server that comprises or controls the dynamically reservable cache resources; and an amount of cache resources available to be reserved.

The profile storage network node 107 may receive a registration request 202 from the user plane network node 110 to register the capabilities of the user plane network node 110 with the communication network. The registration request 202 can indicate that the capabilities of the user plane network node 110 comprise the capability, responsive to a cache request, to dynamically reserve cache resources for use by one or more content providers.

The registration request 202 may further comprise one or more of: an address of a cache server that comprises or controls the dynamically reservable cache resources; and an amount of cache resources available to be reserved.

The profile storage network node 107 may send a response 204 to the user plane network node 110 indicating that a profile for the user plane network node 110 has been stored.

The profile storage network node 107 may further receive, from an exposure network node 103, a discovery request 213 that requests the profile storage network node 107 to identify one or more user plane network nodes 110 that have the capability to dynamically reserve cache resources for use by one or more content providers responsive to a cache request.

The discovery request 213 may further indicate an amount of cache resources to be reserved by a user plane network node 110.

In some embodiments, the profile storage network node 107 may further send, to the exposure network node 103, a discovery response 215 that identifies one or more user plane network nodes 110 that have the capability to dynamically reserve cache resources for use by one or more content providers responsive to a cache request.

The discovery response 215 may further indicate, for an identified user plane network node 110, one or both of an address of a cache server that comprises or controls the dynamically reservable cache resources; and an amount of cache resources available to be reserved.

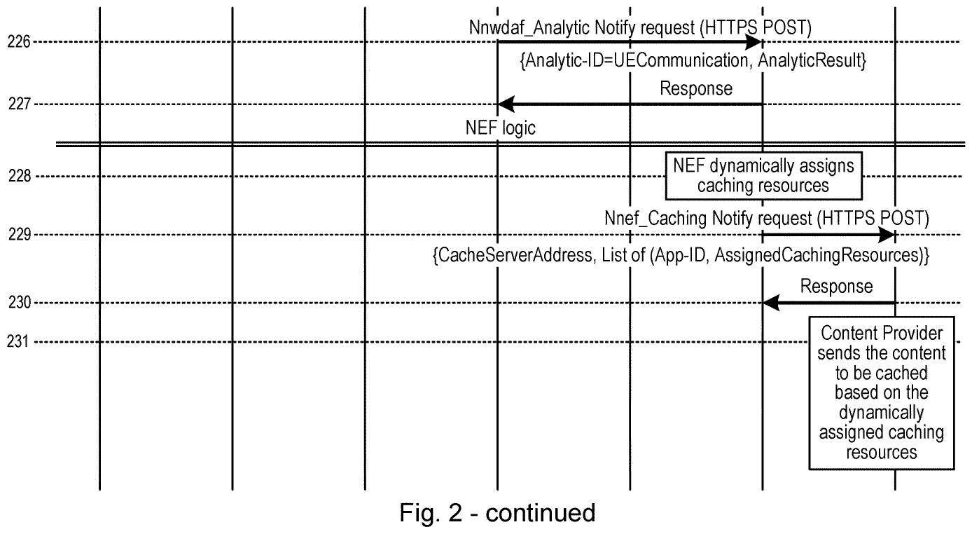

FIG. 5 is a flow chart illustrating a method of operating an application network node 105 (e.g. an AF/AS or SCS/AS) according to various embodiments. The application network node 105 may perform the method in response to executing suitably formulated computer readable code. The computer readable code may be embodied or stored on a computer readable medium, such as a memory chip, optical disc, or other storage medium. The computer readable medium may be part of a computer program product.

In step 501, the application network node 105 sends, to an exposure network node 103 in a communication network, a cache request 206 that requests cache resources in the communication network be reserved for use by a first content provider.

The cache request 206 may comprise one or more of: an indication of an amount of cache resources required by the first content provider; an indication of one or more user equipments, UEs 200, or one or more groups of UEs 200, that the cache request 206 applies to; an identifier of the first content provider that the cache request 206 relates to; one or more application identifiers that identify a respective application of the first content provider that the cache request 206 relates to; an indication of an amount of cache resources required for the respective application.

The method in the application network node 105 may further comprise receiving, from the exposure network node 103, a response 211 indicating that the cache request 206 has been stored.

The method in the application network node 105 may further comprise receiving, from the exposure network node 103, a cache notification message 229 indicating that cache resources have been reserved for use by the first content provider. The cache notification message 229 may indicate one or more of: an address of a cache server that comprises or controls the cache resources reserved for use by the first content provider; one or more application identifiers that identify a respective application of the first content provider that the cache resources have been reserved for; and an indication of an amount of cache resources reserved for the respective application.

The method in the application network node 105 may further comprise sending, to the exposure network node 103, a response 230 acknowledging the cache notification message 229.

The method in the application network node 105 may further comprise receiving 231 content to be stored from the first content provider; and sending 231 the content to the cache resources that have been reserved for use by the first content provider.

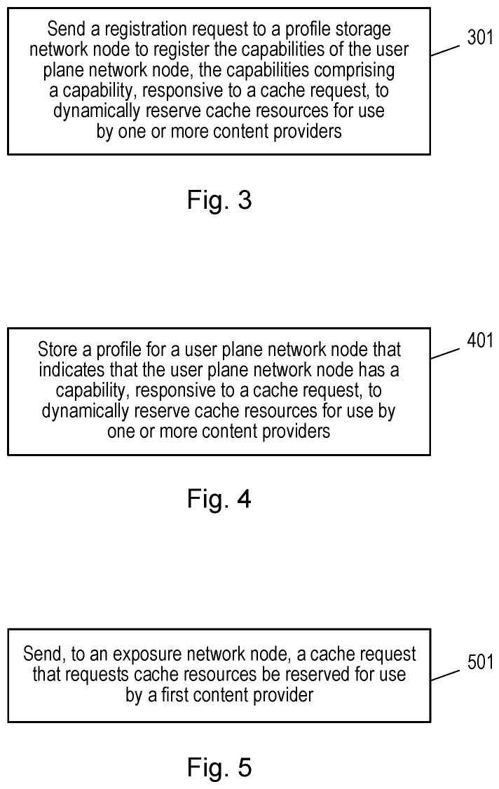

FIG. 6 is a flow chart illustrating a method of operating an exposure network node 103 (e.g. a NEF or SCEF) according to various embodiments. The exposure network node 103 is part of a communication network. The exposure network node 103 may perform the method in response to executing suitably formulated computer readable code. The computer readable code may be embodied or stored on a computer readable medium, such as a memory chip, optical disc, or other storage medium. The computer readable medium may be part of a computer program product.

In step 601, in response to a cache request 206 that requests cache resources in the communication network be reserved for use by a first content provider, the exposure network node 103 reserves 228 cache resources in the communication network for use by the first content provider.

In step 603, the exposure network node 103 sends, to the application network node 105, a cache notification request 229 indicating the reserved cache resources.

The cache notification message 229 may indicate one or more of: an address of a cache server that comprises or controls the cache resources reserved for use by the first content provider; one or more application identifiers that identify a respective application of the first content provider that the cache resources have been reserved for; and an indication of an amount of cache resources reserved for the respective application.

The method in the exposure network node 103 may further comprise receiving, from the application network node 105, a response 230 acknowledging the cache notification message 229.

The method in the exposure network node 103 may further comprise receiving, from an application network node 105, the cache request 206.

The cache request (206) may comprise one or more of: an indication of an amount of cache resources required by the first content provider; an indication of one or more user equipments, UEs 200, or one or more groups of UEs 200, that the cache request 206 applies to; an identifier of the first content provider that the cache request 206 relates to; one or more application identifiers that identify a respective application of the first content provider that the cache request 206 relates to; an indication of an amount of cache resources required for the respective application.

The method in the exposure network node 103 may further comprise determining whether the application network node 105 is authorised to make the cache request 206.

The method in the exposure network node 103 may further comprise sending, to a user data storage network node 102, a write request 208 that comprises information from the cache request 206. The method in the exposure network node 103 may further comprise receiving, from the user data storage network node 102, a response message 210 indicating that the user data storage network node 102 has stored the information from the cache request 206. The method in the exposure network node 103 may further comprise sending, to the application network node 105, a response 211 indicating that the cache request 206 has been stored.

The method in the exposure network node 103 may further comprise sending, to a profile storage network node 107, a discovery request 213 that requests the profile storage network node 107 identify one or more user plane network nodes 110 that have the capability to dynamically reserve cache resources for use by one or more content providers responsive to a cache request. The discovery request 213 may further indicate an amount of cache resources to be reserved by a user plane network node 110.

The method in the exposure network node 103 may further comprise receiving, from the profile storage network node 107, a discovery response 215 that identifies one or more user plane network nodes 110 that have the capability to dynamically reserve cache resources for use by one or more content providers responsive to a cache request.

The discovery response 215 may further indicate, for an identified user plane network node 110, one or both of an address of a cache server that comprises or controls the dynamically reservable cache resources; and an amount of cache resources available to be reserved.

The method in the exposure network node 103 may further comprise storing 216 the identity of the one or more user plane network nodes 110 identified in the discovery response 215.

The method in the exposure network node 103 may further comprise sending, to a user data storage network node 102, a read request 218 that requests information on cache requests from one or more content providers; and receiving, from the user data storage network node 102, a response message 220 that comprises information on cache requests from one or more content providers.

The response message 220 may comprise: one or more application identifiers that identify a respective application of the first content provider that a cache request 206 relates to; and/or an indication of an amount of cache resources required for the respective application.

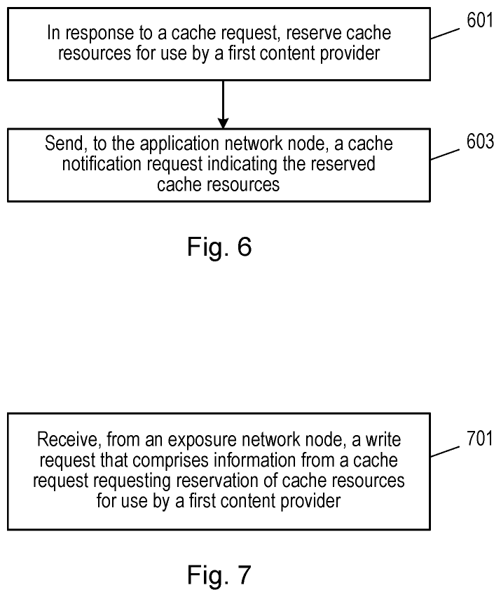

FIG. 7 is a flow chart illustrating a method of operating a user data storage network node 102 (e.g. a UDR or SPR) according to various embodiments. The user data storage network node 102 is part of a communication network.

The user data storage network node 102 may perform the method in response to executing suitably formulated computer readable code. The computer readable code may be embodied or stored on a computer readable medium, such as a memory chip, optical disc, or other storage medium. The computer readable medium may be part of a computer program product.

In step 701, the user data storage network node 102 receives, from an exposure network node 103, a write request 208 that comprises information from a cache request 206 that requests cache resources in the communication network be reserved for use by a first content provider.

The method in the user data storage network node 102 may further comprise storing 209 the information from the cache request 206. The method in the user data storage network node 102 may further comprise sending, to the exposure network node 103, a response message 210 indicating that the user data storage network node 102 has stored the information from the cache request 206.

The method in the user data storage network node 102 may further comprise receiving, from the exposure network node 103, a read request 218 that requests information on cache requests from one or more content providers; and sending, to the exposure network node 103, a response message 220 that comprises information on cache requests from one or more content providers. The response message 220 may comprise: one or more application identifiers that identify a respective application of the first content provider that a cache request 206 relates to; and/or an indication of an amount of cache resources required for the respective application.

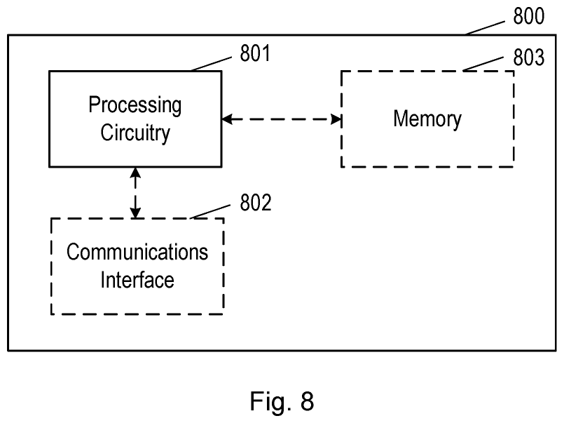

FIG. 8 is a simplified block diagram of a network node 800 according to some embodiments that can be used to implement one or more of the techniques described herein. The network node 800 can be or implement any one or more of the user plane network node, profile storage network node, application network node, exposure network node and user data storage network node described herein. In particular embodiments, the network node 800 can be or implement any one or more of the NFs used in the 5G implementation of the techniques described herein, such as the UDR 102, NEF 103, NWDAF 104, AF/AS 105, PCF 106, NRF 107, SMF 109 and UPF 110. In other embodiments, the network node 800 can be or implement any one or more of the functions used in the 4G implementation of the techniques described herein, such as the SPR, SCEF, SCS/AS, PCRF, PGW-C/TDF-C, and PGW-U/TDF-U.

The network node 800 comprises processing circuitry (or logic) 801. It will be appreciated that the network node 800 may comprise one or more virtual machines running different software and/or processes. The network node 800 may therefore comprise, or be implemented in or as one or more servers, switches and/or storage devices and/or may comprise cloud computing infrastructure that runs the software and/or processes.

The processing circuitry 801 controls the operation of the network node 800 to implement the relevant part of the methods described herein. The processing circuitry 801 can comprise one or more processors, processing units, multi-core processors or modules that are configured or programmed to control the network node 800 in the manner described herein. In particular implementations, the processing circuitry 601 can comprise a plurality of software and/or hardware modules that are each configured to perform, or are for performing, individual or multiple steps of the method described herein in relation to the network node 800.

The network node 800 also comprises a communications interface 802. The communications interface 802 is for use in enabling communications with other network node, computers, servers, etc. For example, the communications interface 802 can be configured to transmit to and/or receive from other network nodes requests, acknowledgements, information, data, signals, or similar. The communications interface 802 can use any suitable communication technology.

The processing circuitry 801 may be configured to control the communications interface 802 to transmit to and/or receive from other network nodes, etc. requests, acknowledgements, information, data, signals, or similar, according to the methods described herein.

The network node 800 may comprise a memory 803. In some embodiments, the memory 803 can be configured to store program code that can be executed by the processing circuitry 801 to perform the method described herein in relation to the network node 800. Alternatively or in addition, the memory 803 can be configured to store any requests, acknowledgements, information, data, signals, or similar that are described herein. The processing circuitry 801 may be configured to control the memory 803 to store such information therein.

Although the network node may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

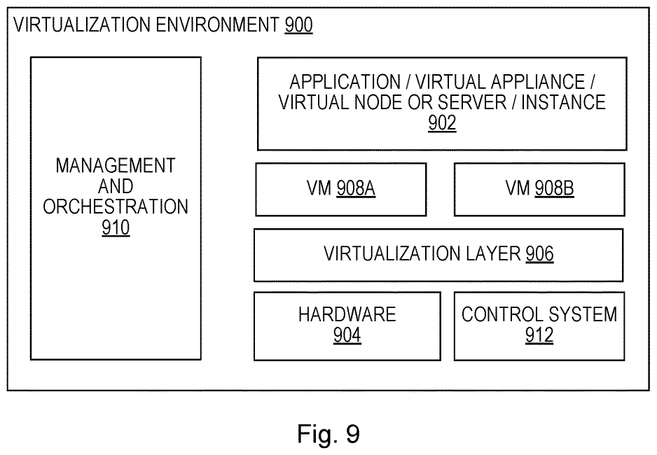

FIG. 9 is a block diagram illustrating a virtualization environment 900 in which functions implemented by some embodiments may be virtualized.

In the present context, virtualizing means creating virtual versions of network nodes which may include virtualizing hardware platforms, storage devices and networking resources. As used herein, virtualization can be applied to any network node described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 900 hosted by one or more of hardware nodes, such as a hardware computing device that operates as a network node. Further, the network node may be entirely virtualized.

Applications 902 (which may alternatively be called software instances, virtual appliances, network functions, virtual nodes, virtual network functions, etc.) are run in the virtualization environment 900 to implement some of the features, functions, and/or benefits of some of the embodiments disclosed herein.

Hardware 904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 906 (also referred to as hypervisors or virtual machine monitors (VMMs)), provide VMs 908a and 908b (one or more of which may be generally referred to as VMs 908), and/or perform any of the functions, features and/or benefits described in relation with some embodiments described herein. The virtualization layer 906 may present a virtual operating platform that appears like networking hardware to the VMs 908.

The VMs 908 comprise virtual processing, virtual memory, virtual networking or interface and virtual storage, and may be run by a corresponding virtualization layer 906. Different embodiments of the instance of a virtual appliance 902 may be implemented on one or more of VMs 908, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 908 may be a software implementation of a physical machine that runs programs as if they were executing on a physical, non-virtualized machine. Each of the VMs 908, and that part of hardware 904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 908 on top of the hardware 904 and corresponds to the application 902.

Hardware 904 may be implemented in a standalone network node with generic or specific components. Hardware 904 may implement some functions via virtualization. Alternatively, hardware 904 may be part of a larger cluster of hardware (e.g. such as in a data center or CPE) where many hardware nodes work together and are managed via management and orchestration 910, which, among others, oversees lifecycle management of applications 902. In some embodiments, hardware 904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signalling can be provided with the use of a control system 912 which may alternatively be used for communication between hardware nodes and radio units.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the scope of the disclosure. Various exemplary embodiments can be used together with one another, as well as interchangeably therewith, as should be understood by those having ordinary skill in the art.

### Abbreviations

At least some of the following abbreviations may be used in this disclosure. If there is an inconsistency between abbreviations, preference should be given to how it is used above. If listed multiple times below, the first listing should be preferred over any subsequent listing(s).

| | |
|---|---|
| AF | Application Function |
| AMF | Access and Mobility Function |
| AOI | Area of Interest |
| AS | Application Server |
| CDN | Content Delivery Network |
| CP | Control Plane |
| DNN | Data Network Name |
| DNS | Domain Name System |
| DPI | Deep Packet Inspection |
| HTTP | Hypertext Transport Protocol |
| HTTPS | Hypertext Transport Protocol Secure |
| IE | Information Element |
| IMEI | International Mobile Equipment Identifier |
| IMSI | International Mobile Subscriber Identifier |
| IP | Internet Protocol |
| ISP | Internet Service Provider |
| IX | Internet Exchange |
| MBB | Mobile Broadband |
| ML | Machine Learning |
| MNO | Mobile Network Operator |
| NRF | Network Resource Function |
| OAM | Operation Administration and Maintenance |
| OTT | Over The Top |
| PCC | Policy Charging and Control |
| PCEF | Policy and Charging Enforcement Function |
| PCF | Policy Control Function |
| PCRF | Policy Control Rules Function |
| PDN | Packet Data Network |
| PDR | Packet Detection Rule |
| PEI | Permanent Equipment Identity |
| PFCP | Packet Flow Control Protocol |
| PFD | Packet Flow Description |
| PGW-CPDN | Gateway Control plane function |
| PGW-UPDN | Gateway User plane function |
| CDMA | Code Division Multiplexing Access |
| CGI | Cell Global Identifier |
| CIR | Channel Impulse Response |
| CP | Cyclic Prefix |
| CPICH | Common Pilot Channel |
| CPICH | Ec/No CPICH Received energy per chip divided by |
| | the power density in the band |
| CQI | Channel Quality information |
| C-RNTI | Cell RNTI |
| CSI | Channel State Information |
| DCCH | Dedicated Control Channel |
| DL | Downlink |
| DM | Demodulation |
| DMRS | Demodulation Reference Signal |
| DRX | Discontinuous Reception |
| DTX | Discontinuous Transmission |
| DTCH | Dedicated Traffic Channel |
| DUT | Device Under Test |
| E-CID | Enhanced Cell-ID (positioning method) |
| eMBMS | evolved Multimedia Broadcast Multicast Services |
| E-SMLC | Evolved-Serving Mobile Location Centre |
| ECGI | Evolved CGI |
| eNB | E-UTRAN NodeB |
| ePDCCH | Enhanced Physical Downlink Control Channel |
| E-SMLC | Evolved Serving Mobile Location Center |
| E-UTRA | Evolved UTRA |
| E-UTRAN | Evolved UTRAN |
| FDD | Frequency Division Duplex |
| FFS | For Further Study |
| gNB | Base station in NR |
| GNSS | Global Navigation Satellite System |
| HARQ | Hybrid Automatic Repeat Request HO Handover |
| HSPA | High Speed Packet Access |
| HRPD | High Rate Packet Data |
| LOS | Line of Sight |
| LPP | LTE Positioning Protocol |
| RAN | Radio Access Network |
| RAT | Radio Access Technology |
| RLC | Radio Link Control |
| RLM | Radio Link Management |
| RNC | Radio Network Controller |
| RNTI | Radio Network Temporary Identifier |
| RRC | Radio Resource Control |
| RRM | Radio Resource Management |
| RS | Reference Signal |
| RSCP | Received Signal Code Power |
| RSRP | Reference Symbol Received Power OR Reference |
| | Signal Received Power |
| RSRQ | Reference Signal Received Quality OR Reference |
| | Symbol Received Quality |
| RSSI | Received Signal Strength Indicator |
| RSTD | Reference Signal Time Difference |
| SCH | Synchronization Channel |
| SCell | Secondary Cell |
| SDAP | Service Data Adaptation Protocol |
| SDU | Service Data Unit |
| SFN | System Frame Number |
| SGW | Serving Gateway |
| PUI | Public User Identity |
| QoE | Quality of Experience |
| QoS | Quality of Service |
| SCS/AS | Service Capability Server/Application Server |
| SDF | Service Data Flow |
| SF | Service Function |
| SMF | Session Management Function |
| S-NSSAI | Single Network Slice Selection Assistance Information |
| SPR | Subscriber Profile Repository |
| SUPI | Subscription Permanent Identifier |
| TCP | Transmission Control Protocol |
| TDF | Traffic Detection Function |
| TDF-C | Traffic Detection Function Control plane |
| TDF-U | Traffic Detection Function User plane |
| TLS | Transport Layer Security |
| UDF | User Datagram Protocol |
| UDR | Unified Data Repository |
| UP | User Plane |
| UPF | User Plane Function |
| 3GPP | 3rd Generation Partnership Project |
| 5G | 5th Generation |
| 6G | 6th Generation |
| ABS | Almost Blank Subframe |
| ARQ | Automatic Repeat Request |
| AWGN | Additive White Gaussian Noise |
| BCCH | Broadcast Control Channel |
| BCH | Broadcast Channel |
| CA | Carrier Aggregation |
| CC | Carrier Component |
| CCCH SDU | Common Control Channel SDU |
| LTE | Long-Term Evolution |
| MAC | Medium Access Control |
| MAC | Message Authentication Code |
| MBSFN | Multimedia Broadcast multicast service Single |
| | Frequency Network |
| MBSFN ABS | MBSFN Almost Blank Subframe |
| MDT | Minimization of Drive Tests |
| MIB | Master Information Block |
| MME | Mobility Management Entity |
| MSC | Mobile Switching Center |
| NPDCCH | Narrowband Physical Downlink Control Channel |
| NR | New Radio |
| OCNG | OFDMA Channel Noise Generator |
| OFDM | Orthogonal Frequency Division Multiplexing |
| OFDMA | Orthogonal Frequency Division Multiple Access |
| OSS | Operations Support System |
| OTDOA | Observed Time Difference of Arrival |
| O&M | Operation and Maintenance |
| PBCH | Physical Broadcast Channel |
| P-CCPCH | Primary Common Control Physical Channel |
| PCell | Primary Cell |
| PCFICH | Physical Control Format Indicator Channel |
| PDCCH | Physical Downlink Control Channel |
| PDCP | Packet Data Convergence Protocol |
| PDP | Profile Delay Profile |
| PDSCH | Physical Downlink Shared Channel |
| PGW | Packet Gateway |
| PHICH | Physical Hybrid-ARQ Indicator Channel |
| PLMN | Public Land Mobile Network |
| PMI | Precoder Matrix Indicator |
| PRACH | Physical Random Access Channel |
| PRS | Positioning Reference Signal |
| PSS | Primary Synchronization Signal |
| PUCCH | Physical Uplink Control Channel |
| PUSCH | Physical Uplink Shared Channel |
| RACH | Random Access Channel |
| QAM | Quadrature Amplitude Modulation |
| SI | System Information |
| SIB | System Information Block |
| SNR | Signal to Noise Ratio |
| SON | Self Optimized Network |
| SS | Synchronization Signal |
| SSS | Secondary Synchronization Signal |
| TDD | Time Division Duplex |
| TDOA | Time Difference of Arrival |
| TOA | Time of Arrival |
| TSS | Tertiary Synchronization Signal |
| TTI | Transmission Time Interval |
| UE | User Equipment |
| UL | Uplink |
| UMTS | Universal Mobile Telecommunications System |
| USIM | Universal Subscriber Identity Module |
| UTDOA | Uplink Time Difference of Arrival |
| UTRA | UMTS Terrestrial Radio Access |
| UTRAN | UTRA Network |
| WCDMA | Wide CDMA |
| WLAN | Wide Local Area Network |

1-12. (canceled)

13. A method of operating an application network node, the method comprising:
sending, to an exposure network node in a communication network, a cache request that requests cache resources in the communication network be reserved for use by a first content provider.

14. The method of claim 13, wherein the cache request comprises one or more of: an indication of an amount of cache resources required by the first content provider; an indication of one or more user equipments (UEs), or one or more groups of UEs, that the cache request applies to; an identifier of the first content provider that the cache request relates to; one or more application identifiers that identify a respective application of the first content provider that the cache request relates to; an indication of an amount of cache resources required for the respective application.

15. The method of claim 13, wherein the method further comprises:
receiving, from the exposure network node, a response indicating that the cache request has been stored.

16. The method of claim 13, wherein the method further comprises:
receiving, from the exposure network node, a cache notification message indicating that cache resources have been reserved for use by the first content provider.

17. The method of claim 16, wherein the cache notification message indicates one or more of: an address of a cache server that comprises or controls the cache resources reserved for use by the first content provider; one or more application identifiers that identify a respective application of the first content provider that the cache resources have been reserved for; and an indication of an amount of cache resources reserved for the respective application.

18-19. (canceled)

20. A method of operating an exposure network node in a communication network, the method comprising:
in response to a cache request that requests cache resources in the communication network be reserved for use by a first content provider, reserving cache resources in the communication network for use by the first content provider; and
sending, to the application network node, a cache notification request indicating the reserved cache resources.

21. The method of claim 20, wherein the cache notification message indicates one or more of: an address of a cache server that comprises or controls the cache resources reserved for use by the first content provider; one or more application identifiers that identify a respective application of the first content provider that the cache resources have been reserved for; and an indication of an amount of cache resources reserved for the respective application.

22. The method of claim 20, wherein the method further comprises:
receiving, from the application network node, a response acknowledging the cache notification message.

23. The method of claim 20, wherein the method further comprises:
receiving, from an application network node, the cache request, wherein
the cache request comprises one or more of: an indication of an amount of cache resources required by the first content provider; an indication of one or more user equipments (UEs), or one or more groups of UEs, that the cache request applies to; an identifier of the first content provider that the cache request relates to; one or more application identifiers that identify a respective application of the first content provider that the cache request relates to; an indication of an amount of cache resources required for the respective application.

24-35. (canceled)

36. A method of operating a user data storage network node in a communication network, the method comprising:
receiving, from an exposure network node, a write request that comprises information from a cache request that requests cache resources in the communication network be reserved for use by a first content provider.

37. The method of claim 36, wherein the method further comprises:
storing the information from the cache request.

38. The method of claim 37, wherein the method further comprises:
sending, to the exposure network node, a response message indicating that the user data storage network node has stored the information from the cache request.

39. The method of claim 36, wherein the method further comprises:
receiving, from the exposure network node, a read request that requests information on cache requests from one or more content providers;
sending, to the exposure network node, a response message that comprises information on cache requests from one or more content providers.

40-44. (canceled)

45. A network node, the network node comprising:
processing circuitry configured to cause the network node to perform the method of claim 13; and
power supply circuitry configured to supply power to the processing circuitry.

46. A network node, the network node comprising:
processing circuitry configured to cause the network node to perform the method of claim 20; and
power supply circuitry configured to supply power to the processing circuitry.

47. A network node, the network node comprising:
processing circuitry configured to cause the network node to perform the method of claim 36; and
power supply circuitry configured to supply power to the processing circuitry.
